(19) United States
(12) Patent Application Publication
(10) Pub. No.: US 2024/0011849 A1
(43) Pub. Date: Jan. 11, 2024

(54) A SYSTEM FOR MONITORING AND CALCULATING THE ENERGY SAVING AND CO2 EMISSION REDUCTION

(71) Applicant: TEKNOVIS3 S.R.L., Chieti (IT)

(72) Inventors: Luca Sutti, Cepagatti (IT); Ercole Sutti, Chieti (IT)

(21) Appl. No.: 18/044,769

(22) PCT Filed: Sep. 20, 2021
(86) PCT No.: PCT/IB2021/058527

§ 371 Date: Mar. 9, 2023

(30) Foreign Application Priority Data
Sep. 28, 2020 (IT) 102020000022858

(51) Int. Cl. G01K 17/00

(52) U.S. Cl. CPC G01K 17/00

(57) ABSTRACT

A system for monitoring and calculating the energy saving and reduction of CO2 emission applied to an element provided with an insulation system. The system comprises an electronic device, an input module, and an output module. The device is adapted to receive from the input module input parameters characterizing the scenario of application related to the element and insulation system, and data measured by sensors integrated into the input module. The electronic device is adapted to calculate the energy saving as the difference between the dispersed heat of the element devoid of insulation and the dispersed heat of the element with the insulator and it is adapted to calculate the energy saving and reduction of the emission of CO₂ multiplying the energy saving obtained by a “g” factor of carbon dioxide emissions from gross thermoelectric fuel production. Lastly, the output module comprises storage means adapted to store the measured data and displaying means adapted to display, in numerical and graphic form, the results of the processing of the measured data.

### CROSS-REFERENCE TO RELATED APPLICATIONS

This application claims priority to PCT International Application No. PCT/IB2021/058527 filed on Sep. 20, 2021, which applications claims priority to Italian Patent Application No. 102020000022858 filed on Sep. 28, 2020, the entire disclosures of which are expressly incorporated herein by reference.

### STATEMENT RE: FEDERALLY SPONSORED RESEARCH/DEVELOPMENT

Not Applicable

### BACKGROUND

### Field of the Invention

The present invention relates to a system for monitoring and calculating the energy saving and CO₂ emission reduction in a continuous and automated manner in a customizable time interval. Such invention can be used in the civil, industrial and agricultural field, and is applicable to all types of elements (valves, pipes, flanges, filters, expansion tanks, pump bodies, tanks etc . . . ) with any method of hard and soft insulation.

### Known Prior Art

Currently, it is only possible to obtain the result produced by the suggested system by carrying out the manual measurements, in one or more instants, with environmental parameters, such as temperature and humidity, such as, for example, the temperature on the outer surface of the bare element and the temperature on the outer surface of the insulating cover.

After collecting all the parameters needed for the calculation and the acquired measurements, convenient mathematical formulas are applied for determining the energy saving and CO₂ emission reduction.

Therefore, at present, there is no automated solution for the continuous and constant monitoring of the energy saving and CO₂ emission reduction with the display option in real time, on the local display of the device and/or on a specific software application (webapp and/or app).

### SUMMARY OF THE INVENTION

In particular, the system for monitoring and calculating the energy saving and CO₂ emission reduction includes an ambient humidity and temperature sensor, sensors for measuring the surface temperature of the insulated element and the outer insulation surface.

The monitoring and calculation system, according to the present invention, allows a continuous and automated measuring in time, processing the data recorded in real time and determining, besides the thermal delta, the energy saving and CO₂emission reduction obtained using the insulation, with the display option in real time on a local display of a device of the system and/or on a specific software application (webapp and/or app).

The solution suggested herein allows a monitoring in real time and an automated and continuous calculation, for varying periods of time (daily, weekly, monthly, annually), of the energy saving and can be applied to all types of elements to be monitored.

Such solution can be used in the civil, industrial and agricultural field, on all elements, which disperse energy in the form of heat and to which an insulation has been applied with an insulating material of any type and method (movable or fixed, hard or soft).

For determining the calculation of the energy saving, after applying an insulation system to an element, which disperses energy in the form of heat, the current technological system comprises a recording, of the manual type, in one or more instants of time.

The same limits of the manual action render the continuous cyclical recording for prolonged periods of time problematic, as in the case of constant monitoring, and the necessary consideration of changes in said period of time, in the ambient and operating parameters of the element, which have an impact on the results.

In particular, the limits of the manual method are:
for continuous monitoring, in real time, difficulty in determining the trend of the saving and CO₂ emission reduction linked to the elevated necessary repetitiveness and frequency of the measurements to be carried out for varying periods of time,
introduction of possible errors deriving from the operator's manual actions;
the difficulty of a rapid historicization of the acquired and calculated data;
the sharing thereof on a telematic platform;
the slowness of the acquisition/calculation operations and data representation; and
the dangerousness of the measurement operations in the presence of environments with elevated temperatures or other criticalities for the safety of personnel.

Therefore, in the case of recording and calculation using a manual methodology, the costs would indeed be higher and not comparable with an automated monitoring and calculating system.

By using such monitoring and calculation system, a new calculation procedure is introduced for obtaining the energy saving and CO₂ emission reduction, through the automation and continuity in time of the recording process on the elements, which are the subject of the monitoring.

### BRIEF DESCRIPTION OF THE FIGURES

Further features and advantages of the invention will be apparent from the reading of the following description provided by way of non-limiting example, with the aid of the figures shown in the accompanying tables, wherein:

FIG. 1 shows an example of an automated monitoring and calculation system according to the present invention;

FIG. 2 shows the system in FIG. 1 with further details;

FIG. 3 is a flow diagram of the steps of the procedure for processing the data carried out by the automated monitoring and calculation system.

The parts according to the present description have been depicted in the drawings, where appropriate, with conventional symbols, showing only those specific details, which are relevant to understanding the embodiments of the present invention, so as not to highlight details, which will be immediately apparent to an expert skilled in the art, with reference to the description reported herein.

### DETAILED DESCRIPTION OF THE INVENTION

Determining and monitoring the energy saving and CO₂ emission reduction obtained from an insulated element 40 with an insulation system 42, for varying periods of time, is carried out by applying a system 1 made up of an electronic device 10. Preferably, the electronic device 10 is inserted into a protective container for indoor or outdoor spaces with a transparent lid (or alternatively, a non-transparent lid). The electronic device 10 is provided with network connectivity, which automatically acquires the temperatures and other parameters, for calculating, in real time, the energy saving and CO₂ emission reduction for the historicization of the data in a cloud database 34 and displaying the data, e.g. on a display 36.

The system 1 is made up of a hardware component, i.e. the aforesaid electronic device 10, which comprises a processing module 12, a network connectivity module 14 and a software module 16 integrated therein.

The processing module 12 can be, for example, a computer with a single board (SBC: Single Board Computer). It is a complete computer, powered by mains, Power over Ethernet (PoE), or a rechargeable battery, built on a single circuit board, with a microprocessor, a memory, input/output peripherals (I/0), wired and wireless network connectivity, and USB connections.

The USB connections can be used for the following two functions:

1) Service connection for system maintenance activities (e.g. system firmware updating).

2) For the optional removal of the data if a network connection is impossible.

The wired and/or wireless network connectivity module 14 is obtained by means of a hardware interface integrated onto the single-board computer SBC and allows the reception and transmission of data from and to the Internet for the reading and writing of the data in the cloud database 34.

The cloud database 34 allows the storage of data, such as: the acquired measurements, the values processed by the device 10 and the operating parameters 22 of the processing module 12.

The device 10, which is conveniently initialized by an input module 20 with parameters 22 characterizing the scenario of application related to the determined element 40 and insulation system 42 under observation and monitoring, is also provided with integrated sensors 24 for measuring the ambient humidity and temperature and with other sensors for measuring the surface temperature of the element 40 and of the insulating system 42.

Digital type ambient humidity and temperature sensors 24, e.g. DHT11 OR DHT22 sensors are used for recording ambient humidity and temperature.

Differently, as surface temperature sensors, contact thermocouples with an NTC thermistor are used, for example, or resistance thermometers PT100/1000 or other types of sensors.

The recording of the ambient humidity and temperature is carried out by means of an analog or digital sensor, connected with or without a wire, to the processing module 12, and integrated into the same container of the device 10 or, optionally installed in a point of the environment surrounding the element 40, which is the subject of the monitoring.

The measurements are carried out respecting the operating temperature ranges related to the sensors used in particular, and in general they can be carried out in outdoor and indoor spaces with varying duration and frequency.

The measurement of the ambient humidity and temperature is carried out by means of an analog or digital sensor, connected with or without a wire to the processing module 12, integrated into the same container of the device 10 or, optionally, installed in a point of the environment surrounding the element 40.

The measurement of the surface temperature of the element 40 (inside the insulating system 42) can be carried out at all times and in all atmospheric conditions, and is carried out by means of a contact thermocouple, which is impermeable and resistant to atmospheric and aggressive agents, connected with or without a wire to the device 10. The thermocouple is placed beneath the insulation system 42 and in direct contact on a point of the surface of the element 40.

The measurement of the temperature of the outer surface of the insulating system 42 is carried out by means of a contact thermocouple. Preferably, the selected thermocouple is a contact thermocouple, which is impermeable and resistant to atmospheric and aggressive agents, connected with or without a wire, to the device 10, placed on a point of the outer surface of the insulating system 42.

The device 10 acquires the input data by means of a line 26, and processes it in real time according to a determined calculation algorithm, which will be described later on, and is resident in the memory 18 of the same device 10.

After processing, the system 1 returns, by means of a line 32 towards an output module 30, the output values of the energy saving, indicated in the figures with reference RE, expressed simultaneously in different measurement units (example: Smc, MWh, KWh, etc . . . ), and the values of the CO₂, emission reduction indicated with reference RCO2, and also expressed simultaneously in different measurement units (example: Kg, tons, etc . . . ).

The system user has the option of selecting the measurement units based on the needs, avoiding having to possibly convert the results obtained and displayed into the preferred measurement unit.

The processed data is stored in the output module 30 in a cloud database 34 and it is possible to display the results of the data processing on the integrated display 36 in numerical and/or graphic form.

The database 34 is made up of tables univocally linked to each device 10. These tables contain the identification data and operating and calculating parameters for the specific application and the single measurements recorded in time with the selected frequency. A determined measurement and calculation of the energy saving RE and RCO₂ values of the CO₂, emission reduction with the time reference will correspond to each record present in the database 34.

After being started and connected to the Internet, the devices 10 connect to the database 34 and read, from the corresponding table, the operating parameters to be used and successively start the cyclical measurements with a determined frequency. For every measurement, the processing module 12 performs the calculations for finding the value of the energy saving RE and the RCO₂ values of the CO₂ emission reduction of that instant and transmits them to the database 34 with a defined frequency, writing them in a new record of the respective table.

The data stored in the database 34, calculated through the processing module 12, can be read both on a local display 36 of the device 10 and on a specific software application (webapp and/or app) capable of reading and showing, in table or graphic form, one or more measurements on one or more devices 38 (smartphone, tablet, PC) and joining the results thereof, thus obtaining the total energy saving RE and RCO₂ reduction values of CO2 emission, according to determined criteria, such as, e.g. specific periods of time and/or for sets of several devices 10.

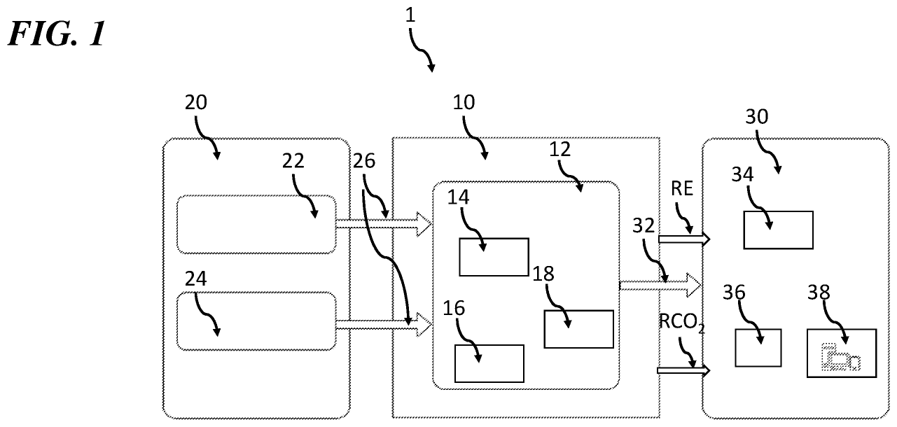

In FIG. 1 the input module 20 comprises means for measuring the initialization data 22 of the system 1, the environmental parameters and the measurements carried out by the sensors 24.

An example of the input module 20 consists of an ambient temperature sensor type DHT22, which provides the temperature of the environment and the humidity, two thermocouples with thermoresistor type NTC100, which provide the temperature of the surface of the element 40 (placed beneath the insulation system) and the temperature of the outer surface of the insulating system 42, respectively.

Such exemplary configuration can be used for any type of element 40 as regards the shape (valves, pipes, flanges, filters, expansion tanks, pump bodies, tanks . . . ) and size.

The device 10 comprises a processing module 12, which obtains the processings based on the input data entering the lines 26 from the module 20.

Finally, again, FIG. 1 shows the output module 30, which allows storing the processed data in a database 34 and displaying it on a display 36. In particular, the results of the energy saving and CO₂ emission reduction obtained by the processing module 12 are sent on the line 32 to the module 30.

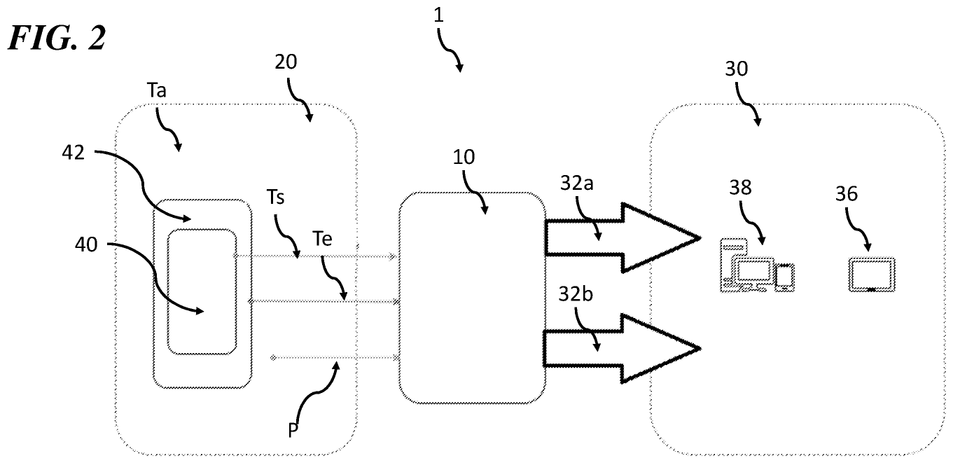

In FIG. 2, the input block 20 represents the input data consisting of the environmental and operating parameters of an element 40 of all shapes and sizes, such as, for example, pipes, flanges, filters, expansion tanks, pump bodies, tanks, etc . . . .

The measurement means comprise sensors for measuring a surface temperature Ts of the element 40 and an outer temperature Te measured on the outer surface of the insulation system 42 (hard and/or soft), insulating the element 40, an ambient temperature Ta surrounding the element. Furthermore, the device 10 receives the input environmental parameters and operating parameters P of the element 40.

The operating and environmental P parameters consist, for example, of: length and diameter of the element 40, annual hours of operation of the element 40, thermal conductivity λ and thickness of the insulator used, fluid/solid heat exchange coefficient hS of the element, conversion factors measurement units from Smc to KWh, conversion factor CO2 from KWh to Kg, parameters related to the thermocouple used, such as T₀ (Nominal resistance temperature), Ro (nominal thermocouple resistance) and Beta (coefficient, correlating T₀ with R₀), measurement frequency timing, identification data of the device and location thereof, descriptive data of the element, installation date, temperature recording time interval.

The device 10 processes the input data (Ts, Te, Ta, P) according to a specific algorithm (described below) and returns the results of the energy saving RE and CO₂ emission reduction indicated as RCO₂.

As shown, at the output block 30, the input data related to the energy saving RE, is sent on the line 32a, (expressed simultaneously in different measurement units, such as, for example: Smc, KWh, MWh, etc . . . ) and the data related to the CO₂ emission reduction, indicated as RCO₂, is sent on the line 32b, (expressed simultaneously in different measurement units, such as, for example: Kg, tons, etc . . . ).

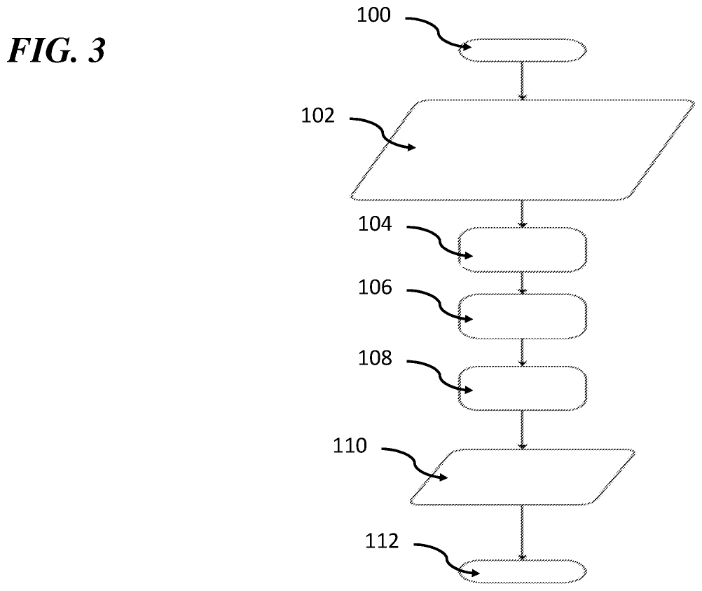

FIG. 3 describes the flow diagram at the base of the algorithm for processing the data carried out by the device.

In one step 100 the algorithm is initialized.

In a successive step 102 the following operations are carried out:

Setting initialization and operating parameters; a setting example is provided: in the case of a pipe, e.g. device identification (000001), Conversion factor from Smc to KWh (10.95), length element (0.53 m), diameter element (0.075 m), annual hours of operation (8500 h), thickness insulator (60 mm), thermal conductivity λ insulator (0.062), heat exchange coefficient hS (15.0), factor for determining the reduction of CO2 from KWh (0.1998), Ro (100000 Ohm), To (25), Beta (3892,0), measurement time interval (900 s), Measurement unit selected for daily report (KWh), Measurement unit selected for Weekly/Monthly/Annual report (MWh), Client, Place of installation, area of application, description element, fluid type;

Acquisition ambient humidity and temperature, by means of an analog/digital humidity and temperature sensor integrated into the device or possibly positioned in the surrounding environment and connected with or without wire to the device;

Acquisition surface temperature of the element, wherein the measurement of the surface temperature of the element is carried out by means of a contact thermocouple, which is impermeable and resistant to atmospheric and aggressive agents, connected with or without a wire to the calculator module, placed beneath the insulation system and in direct contact on a point of the surface of the element;

Acquisition temperature on the outer surface of the insulation, wherein the measurement of the surface temperature of the element can be carried out at all times and in all atmospheric conditions and it is carried out by means of a contact thermocouple, which is impermeable and resistant to aggressive and atmospheric agents, connected with or without a wire to the calculator module, placed beneath the insulation system and in direct contact on a point of the insulation 42 surface.

In another step 104 a formula is applied for calculating the energy saving.

The estimate of the energy saving (expressed in kWh or MWh or Smc) is obtained with the difference between the dispersed heat Q40 of the “bare” element (devoid of insulation) and the dispersed heat Q42 of the element with the insulation.

The formula for calculating the heat dispersed Q from a cylindrical element by unit of length based on the Fourier Postulate for the conduction of heat, is reported below:

$$Q = \frac{2 * π * K * L ( Tf - Ta )}{Ds * ln ( \frac{Ds}{Do} )} expressed in ( W / m ) ,$$

with the overall thermal conductivity

$$K = \frac{1}{( \frac{1}{hS} ) + λ}$$

where:

L=length of the element to be measured (m) is part of the block parameters 22,

Tf=Fluid temperature inside the element (° C.) deriving from the sensor block 24,

Ta=Ambient temperature surrounding the element (° C.) deriving from the sensor block 24,

Do=Diameter of the ideal cylinder enclosing the volume of the element (m) is part of the block parameters 22,

Ds=Diameter of the ideal cylinder enclosing the volume of the insulator applied to the element (m) is part of the block parameters 22, λ=Thermal conductivity of the applied insulating (W/mK) is part of the block parameters 22,

hS=Heat exchange coefficient of the outer surface of the dependent thermal insulation (W/(m²K)) is part of the block parameters 22,

Successively, in a step 106 the formula is applied for calculating the CO₂ emission reduction.

The calculation of the CO₂ emission reduction is obtained multiplying the energy saving obtained in kWh by the factor g of carbon dioxide emissions from gross thermoelectric fuel production (CO₂/kWh). Such factor is published annually by the Institute for Environmental Protection and Research (ISPRA).

The historicization of the data in the database 34 is carried out in the step indicated with reference 108. The historicization of the data in the database 34 is carried out by writing in the Cloud database by virtue of the connection to the Internet provided by the module 14 of the device 10.

The device 10 cyclically writes in the tables of the database 34, with a determined frequency, the values recorded, the fields processed and the time reference for the measurement carried out.

Finally, step 110 displays the thermal delta, the energy saving RE and the CO₂ emission reduction as the variable RCO₂.

The procedure terminates in a step 112.

Based on the specific needs of the application, the system 1 can comprise variants with respect to the standard version, e.g. an output module 30 without an integrated display 36, and/or with a rechargeable battery instead of the mains supply. If the system 1 is devoid of the integrated display 36, the container can have a non-transparent cover. The protective container for indoor or outdoor spaces can be made of any material and has the purpose of preserving the device 10 from atmospheric agents, knocks, dust and elevated temperatures.

The system 1 provided with a rechargeable battery supply can be used in spaces and situations in which it is difficult to transport the mains supply.

The above description of embodiments of the invention is capable of showing the invention from a conceptual point of view so that others, using the known art, will be able to modify and/or adapt, in various applications, such specific embodiments, without further research and without departing from the inventive concept and, therefore, it is intended that such adaptations and modifications are considered as equivalents of the specific embodiments.

The means and materials for obtaining the various described functions can be of various types without thereby departing from the scope of the invention.

The expressions or terminology used are purely intended for descriptive purposes and are therefore not limiting.

1. A system for monitoring and calculating the energy saving and CO₂ emission reduction applied to an element provided with an insulation system, wherein said system comprises:
an electronic device
an input module, and
an output module,
wherein said device is adapted to receive, from the input module input parameters characterizing the scenario of application and related to said elementand said insulation system and measured data from sensors integrated into the input module,
wherein the electronic device is adapted to calculate the energy saving as the difference between the dispersed heat of the element devoid of insulation and the dispersed heat of the element with the insulator,
wherein the heat dispersed from an element is defined as:
$$Q = \frac{2 * π * K * L ( Tf - Ta )}{Ds * ln ( \frac{Ds}{Do} )}$$
where the overall thermal conductivity is calculated as
$$K = \frac{1}{( \frac{1}{hS} ) + λ}$$
and where:
L=length of the element to be measured,
Tf=Temperature of the fluid inside the element,
Ta=Ambient temperature surrounding the element,
Do=Diameter of the ideal cylinder enclosing the volume of the element,
Ds=Diameter of the ideal cylinder enclosing the volume of the insulator applied to the element,
λ=Thermal conductivity of the applied insulator,
hS=Heat exchange coefficient of the outer surface of the dependent thermal insulator, and
wherein said electronic device is adapted to calculate the energy saving and CO₂ emission reduction multiplying the energy saving obtained by a factor “g” of carbon dioxide emissions from gross thermoelectric fuel production, and
wherein said output module comprises storage means adapted to store the measured data and displaying means adapted to display, in numerical and graphic form, the results of the processing of the measured data.

2. The monitoring system according to claim 1, wherein said electronic device comprises:
a processing module,
a network connectivity module, and
a software module.

3. The monitoring system according to claim 2, wherein said processing module comprises a single-board computer built on a single-circuit board with microprocessor, memory, input/output peripherals, wired and wireless network connectivity, and USB connections.

4. The monitoring system according to claim 2, wherein the network connectivity module consists of a hardware interface integrated on the single-board computer and allows the reception and transmission of data from and to the Internet.

5. The monitoring system according to claim 2, wherein said output module comprises a cloud database which allows the acquired measurements, the processed values and the operating parameters of the processing module to be stored.

6. The monitoring system according to claim 2, wherein said digital temperature and ambient humidity sensors are DHT11 or DHT22 sensors and said surface temperature sensors are contact thermocouples with NTC thermistor or PT100/1000 resistance thermometers.

7. The monitoring and calculation system according to claim 2 wherein said operating and environmental parameters comprise:
length and diameter of the element,
annual hours of operation of the element,
thermal conductivity λ and thickness of the insulator used,
fluid/solid heat exchange coefficient hS of the element,
measurement unit conversion factors, from Smc to KWh,
CO2 conversion factor from KWh to Kg,
parameters related to the thermocouple used such as T₀ (nominal resistance temperature), R₀ (nominal thermocouple resistance) and Beta (coefficient correlating T₀ with R₀),
measurement frequency timing,
identification data of the device and location thereof,
descriptive data of the element,
installation date, and
temperature detection time interval.

8. The monitoring and calculation system according to claim 2, wherein said device is inserted into a protective container for indoor or outdoor spaces with a transparent or non-transparent lid.

9. The monitoring and calculation system according to claim 1, wherein said system is powered by the mains, or Power over Ethernet, and/or a rechargeable battery.

10. A method for monitoring and calculating the energy saving and CO₂ emission reduction applied to an element provided with an insulation system wherein said method comprises a system according to claim 1, wherein said device processes the input data according to the following steps:
setting initialization and operation parameters,
acquiring ambient temperature and humidity;
acquiring the surface temperature of the element by means of a contact thermocouple placed in direct contact on a point of the surface of the element;
acquiring the temperature on the outer surface of the insulation by means of a contact thermocouple placed in direct contact on a point of the surface of the insulation,
applying the formula for calculating the energy saving,
applying the formula for calculating the CO₂ emission reduction,
storing data, and
displaying the value of thermal delta, energy saving and CO₂ emission reduction.

11. The method according to claim 10, wherein the step of inserting the device into a protective container for indoor or outdoor spaces with a transparent or non-transparent lid is included.

12. The method according to claim 10, wherein the system is powered by the mains, or Power over Ethernet, and/or a rechargeable battery.
